(19) United States
(12) Patent Application Publication
(10) Pub. No.: US 2026/0050415 A1
(43) Pub. Date: Feb. 19, 2026

(54) WATCHING FOR VARIABLE OR EXPRESSION CHANGES

(71) Applicant: Arm Limited, Cambridge (GB)

(72) Inventors: Christopher Charles JANUARY, Eastleigh (GB); David Aaron PENRY, Gilbert, AZ (US); Lewis Michael RUSSELL, Bury St. Edmunds (GB)

(21) Appl. No.: 18/795,571

(22) Filed: Aug. 6, 2024

(51) Int. Cl. G06F 8/30

(52) U.S. Cl. CPC G06F 8/30

(57) ABSTRACT

A data processing apparatus includes source input circuitry that receives source code. Modification input circuitry receives a watch modification instruction that indicates an expression or variable, and a modification to be made to the source code at one or more locations in the source code where the expression or variable could change. Processing circuitry applies the modification to the one or more locations in the source code.

### TECHNICAL FIELD

The present disclosure relates to data processing.

### DESCRIPTION

It may be desirable for a computer program to be modifiable to work under different circumstances without the underlying code for that program being changed. For instance, it may be desirable to make changes to a computer program to locations where a variable has the potential to change, for the purposes of debugging.

### SUMMARY

Viewed from a first example configuration, there is provided a data processing apparatus comprising: source input circuitry configured to receive source code; modification input circuitry configured to receive a watch modification instruction that indicates an expression or variable, and a modification to be made to the source code at one or more locations in the source code where the expression or variable could change; and processing circuitry configured to apply the modification to the one or more locations in the source code.

Viewed from a second example configuration, there is provided a data processing method comprising: receiving source code; receiving a watch modification instruction that indicates an expression or variable, and a modification to be made to the source code at one or more locations in the source code where the expression or variable could change; and applying the modification to the one or more locations in the source code.

Viewed from a third example configuration, there is provided a non-transitory storage medium configured to store a computer program that, when executed on a computer causes the computer to: receive source code; receive a watch modification instruction that indicates an expression or variable, and a modification to be made to the source code at one or more locations in the source code where the expression or variable could change; and apply the modification to the one or more locations in the source code.

### BRIEF DESCRIPTION OF THE DRAWINGS

The present invention will be described further, by way of example only, with reference to embodiments thereof as illustrated in the accompanying drawings, in which:

FIG. 1 shows an example system that performs a source code transformation in accordance with some examples;

FIG. 2 illustrates the relationship between source code and a set of ASTs;

FIG. 3 shows an example in which the source code is modified at the level of a particular statement using a pattern;

FIG. 4 shows an example in which the previous applied modification is treated as a compound statement when matching statements;

FIG. 5 shows an example that uses capture groups as part of the pattern;

FIG. 6A illustrates a modification in which the given location is at the entry into a function;

FIG. 6B illustrates a modification in which the given location is the return or exit from a function;

FIG. 6C illustrates a modification in which the given location is the function itself;

FIG. 7A shows an example in which the location is specified as one or more places in the code before a variable is obtained;

FIG. 7B shows an example in which the location is specified as one or more places in the code after a variable is obtained;

FIG. 7C illustrates an example in which the one or more locations are the locations themselves where a variable is obtained;

FIG. 8A shows an example in which the location is specified as one or more places in the code before a global variable is set;

FIG. 8B shows an example in which the location is specified as one or more places in the code after a variable is set;

FIG. 8C shows an example in which the location is specified as one or more places in the code after a variable is set;

FIG. 9 shows an example of an abstract syntax tree matching;

FIG. 10 shows a method in accordance with some examples;

FIG. 11 shows an example of the application of modification instructions to source code to produce an output;

FIG. 12 illustrates a process, in the form of a flowchart, which can be used to handle the determination of locations in the source code;

FIG. 13 illustrates a more complicated example of source code and a modification instruction containing a watch point that can be used to illustrate the process with respect to FIG. 12;

FIG. 14A illustrates an example in which a modification can be instructed to be made prior to points where a variable or expression may change;

FIG. 14B illustrates an example in which a modification can be instructed to be made after points where a variable or expression may change;

FIG. 14C illustrates an example in which a modification can be instructed to replace points where a variable or expression may change;

FIG. 15A shows an example of using modifications and watches together;

FIG. 15B shows the resulting output of performing modifications and watches together; and

FIG. 16 shows a method of data processing in accordance with some embodiments.

### DESCRIPTION OF EXAMPLE EMBODIMENTS

Before discussing the embodiments with reference to the accompanying figures, the following description of embodiments is provided.

In accordance with one example configuration there is provided a data processing apparatus comprising: source input circuitry configured to receive source code; modification input circuitry configured to receive a watch modification instruction that indicates an expression or variable, and a modification to be made to the source code at one or more locations in the source code where the expression or variable could change; and processing circuitry configured to apply the modification to the one or more locations in the source code.

In these examples, the source code may be written in a variety of different programming languages—the specific language is immaterial to the present disclosure. The source code may be provided as a number of different files or as a single file. The modification instruction can also be provided in a number of different formats, and can also be provided as an isolated instruction, a file, or a plurality of files. Modification instructions define a particular expression or variable and a modification to be made in respect of that expression or variable. An expression can be considered to be an element of code that is executed in order to produce a result. The modification is made at locations at which the expression or variable has the potential to change. Note that there is no requirement that the expression or variable does change (which can only be evaluated via execution) but rather that there is a potential for it to change. The modification instruction can also be provided in a number of different formats, and can also be provided as an isolated instruction, a file, or a plurality of files. Note that in some cases, the location may not exist, it may occur once, or it may occur a plurality of times. Regardless, the modification is applied each time. By being able to target each location at which a variable or expression could change, it is possible to target more complicated portions of code in an efficient manner by ‘watching’ locations where a variable can change. This can be useful for, for instance, debugging, where it would be useful to track precisely where a change to an erroneous value occurs for a particular variable. In contrast to use a debugger's ‘watchpoint’, this technique causes a modification to the code at compile time, rather than dynamically querying memory at each instruction, which is time consuming.

In some examples, the processing circuitry is configured to generate an abstract syntax tree from the source code, and to identify the one or more locations using the abstract syntax tree. An abstract syntax tree is a data structure that is used to represent code. The nodes represent individual elements of the text, with edges being used to represent relationships between the elements. For instance, the expression x+5 might be represented by ‘x’, ‘+’, and ‘5’ being nodes, with an edge connecting the ‘x’ and the ‘5’ to the ‘+’, to indicate that the ‘+’ operation is applied to the components ‘x’ and ‘5’. By performing the identification of the location using an abstract syntax tree, it is possible to locate particular portions of the source code without relying of text matching and instead only considering the actual syntax of the source code. That is, portions of the source code are identified based on what they achieve/do rather than the actual text used to represent the code.

In some examples, when the modification instruction comprises a before keyword, the processing circuitry is configured to determine the one or more locations as points immediately before where the expression or variable could change. A modification instruction can include a ‘before’ keyword (e.g. by using the word ‘before’). This indicates that the location(s) in question are locations before which the expression/variable has the potential to be changed. For instance, if the modification instruction were to be ‘before x’ then the modification would cause code to be inserted before locations at which variable x could be changed.

In some examples, when the modification instruction comprises an after keyword, the processing circuitry is configured to determine the one or more locations as points immediately after where the expression or variable could change. A modification instruction can include an ‘after’ keyword (e.g. by using the word ‘after’). This indicates that the location(s) in question are locations after which the expression/variable has the potential to be changed. For instance, if the modification instruction were to be ‘after x’ then the modification would cause code to be inserted after locations at which variable x could be changed.

In some examples, when the modification instruction comprises a replaces keyword, the processing circuitry is configured to determine the one or more locations as points where the expression or variable could change. A modification instruction can include a ‘replaces’ keyword (e.g. by using the word ‘replaces’). This indicates that the location(s) in question are the location(s) themselves at which the expression or variable could change. Thus, if the modification instruction were to be ‘replaces x’ then the modification would cause code to be inserted, replacing locations at which variable x could be changed.

In some examples, the processing circuitry is configured to determine the one or more locations by including assignments made to the variable. An assignment made to a variable that is being ‘watched’ does not necessarily mean that the variable will change. For instance, if the variable x is set to 5 then the assignment x=5 does not actually change the variable. Nevertheless, an assignment is one particular location in which the variable could change.

In some examples, the processing circuitry is configured to determine the one or more locations by determining dependencies of the expression. In the expression x=y+5, if the variable ‘x’ is being watched then it could change at the expression itself, but could also change any time that variable ‘y’ is changed because x is dependent on y.

In some examples, the processing circuitry is configured to determine the one or more locations by including assignments made to the dependencies. Having determined that one variable (that is being watched) is dependent on, for instance, another variable, it is possible to watch changes to the variable by looking for locations where the other variable could be changed. For instance, following the above example, one could target assignments made to the variable y so that a watch placed on variable x will target portions of code where variable y is changed due to the expression x=y+5. In some cases, such locations are restricted to occurring prior to the x=y+5 expression since after this expression, changes to y do not impact x (unless a further expression exists).

In some examples, the dependencies of the expression include one or more indirect dependencies of the expression. Again extending the above example, if y is defined as y=z+8 and z is defined as z=a+b then the variables x is indirectly dependent on the variables a and b and so locations where modifications are to be made can include locations in the source code where a or b could change.

In some examples, the one or more locations in the source code are determined without executing the source code. In these examples, neither the source code (nor any derivative of it) is executed to determine where changes to variables or expressions occur. Instead, such locations are determined by static analysis of the source code (e.g. using an abstract syntax tree or other mechanism).

In some examples, an identifier may be used in the modification to reference the expression or variable. This can act as an implicit or automatic capture group. For instance, the expression {{original}} may be used to refer to the original (unmodified) expression or variable without having to explicitly capture it.

The following list of alternative embodiments is also provided:

In accordance with one alternative example configuration there is provided A data processing apparatus comprising: source input circuitry configured to receive source code; modification input circuitry configured to receive a modification instruction that indicates a location in the source code, and a modification to be made to the source code at the location; and processing circuitry configured to apply the modification to the location in the source code, wherein the processing circuitry is configured to generate an abstract syntax tree from the source code, and to identify the location using the abstract syntax tree.

In these alternative examples, the source code may be written in a variety of different programming languages—the specific language is immaterial to the present disclosure. The source code may be provided as a number of different files or as a single file. The modification instruction can also be provided in a number of different formats, and can also be provided as an isolated instruction, a file, or a plurality of files. Modification instructions define a location or locations within the source code, at which a particular modification should be made. Note that in some cases, the location may not exist, it may occur once, or it may occur a plurality of times. Regardless, the modification is applied each time. The processing circuitry causes the modification to be performed. An abstract syntax tree (AST) is a data structure that is used to represent code. The nodes represent individual elements of the text, with edges being used to represent relationships between the elements. For instance, the expression x+5 might be represented by ‘x’, ‘+’, and ‘5’ being nodes, with an edge connecting the ‘x’ and the ‘5’ to the ‘+’, to indicate that the ‘+’ operation is applied to the components ‘x’ and ‘5’. By performing the identification of the location using an abstract syntax tree, it is possible to locate particular portions of the source code without relying on text matching and instead only considering the abstract syntax of the source code. That is, portions of the source code are identified based on what they achieve/do rather than the actual text used to represent the code. Since an AST, by definition, represents a syntactically valid portion of code, making modifications in this manner allows a fine degree of control while maintaining validity.

In some alternative examples, the location comprises an expression.

In some alternative examples, the location comprises one or more statements. For instance, there may be a plurality of statements.

The distinction between statements and expressions is not always clear in different programming languages. A common definition may consider an expression to be a portion of code that evaluates to a value and a statement to be a portion of code that does not evaluate to a value. However, the present technique allows a location to be specified that incorporates a sequence of statements and expressions that are permitted by the language of the source code.

In some alternative examples, the series of statements are contiguous. For instance, the series of statements that are identified follow one after another. In other alternative examples, the series of statements may be interspersed with other elements that are not explicitly identified in the modification instruction.

In some alternative examples, the modification input circuitry is configured to receive a further modification instruction that indicates a second location; and the second location is in the source code as modified by the modification. In these alternative examples, a first modification instruction might cause the instruction to be modified. It is then the modified code that is tested or matched against a second location in a second modification instruction.

In some alternative examples, the modification instruction defines a capture group, and the modification includes a reference to the capture group. A capture group identifies a portion of the source code against which a match can be made. This could be achieved using wildcards or other classes (e.g. ‘any identifier’, ‘any logical expression’ and so on). The capture group is ‘captured’ in the sense that it may be provided as part of the modification to be performed. In essence, this makes it possible to perform a more complicated matching and to leave certain parts of the source code intact. For instance, a modification instruction might be of the form ‘replaces “x=([0])” “x=([0]); print ‘x is now ([0])’”’. This is a ‘replaces’ style modification (as described below). It searches for a statement “x=5” (e.g. using an AST). A capture group is used to specify the contents of the assignment, and this is referred to as capture group 0. The replacement that occurs is to replace this entire match with the assignment together with a print statement that causes the new value to be output. Importantly, however, the capture group is provided in the replacement via the text [0]. In other words, whatever matched in the assignment is now reinserted into the both the new assignment and the print function. A matching might have multiple capture groups. For instance, the instruction might be of the form ‘replaces [0]([1]) throw(“An attempt was made to call the function [0] with variable [1]”)’ in order to throw an exception indicating the function call that would have been performed, together with the variable.

In some alternative examples, the capture group is identified using an identifier, and the identifier is referenced in the modification. The capture group could also be anonymous. This causes part of the text to be captured in such a way that it cannot be referenced in the modification. Of course, a modification may use a mixture of anonymous and non-anonymous capture groups.

In some alternative examples, the processing circuitry is configured to determine the location using greedy matching. Where there are several ways of matching a part of the source code to the location identified in the modification instruction, the processing circuitry will assume that the largest possible valid match is how the modification instruction is to be applied.

In some alternative examples, when the modification instruction comprises a before keyword, the processing circuitry is configured to determine the location as a point immediately before the statement. A modification instruction can include a ‘before’ keyword (e.g. by using the word ‘before’). This indicates that the location in question that is to be considered occurs before the statement that has been identified. For instance, if the modification instruction were to be ‘before print(x)’ then the modification would cause code to be inserted before instances of the statement ‘print(x)’, while leaving that statement intact. Note that although the location is identified as being before a statement, this does not preclude the use of ASTs to determine that location, and the location can therefore be defined by searching for a particular node of the AST.

In some alternative examples, when the modification instruction comprises an after keyword, the processing circuitry is configured to determine the location as a point immediately after the statement. A modification instruction can include an ‘after’ keyword (e.g. by using the word ‘after’). This indicates that the location in question that is to be considered occurs after the statement that has been identified. For instance, if the modification instruction were to be ‘after print(x)’ then the modification would cause code to be inserted after any instance of the statement ‘print(x)’, while leaving that statement intact. Note that although the location is identified as being after a statement, this does not preclude the use of ASTs to determine that location, and the location can therefore be defined by searching for a particular node of the AST.

In some alternative examples, when the modification instruction comprises a replaces keyword, the processing circuitry is configured to determine the location as the statement. A modification instruction can include a ‘replaces’ keyword (e.g. by using the word ‘replaces’). This indicates that the location in question that is to be considered is the statement itself. Thus, if the modification instruction were to be ‘replaces print(x)’ then the modification would cause each ‘print(x)’ statement to be replaced with replacement code. That is, the original print(x) code would be deleted. Note that although the location is identified as replacing a statement, this does not preclude the use of ASTs to determine that location, and the location can therefore be defined by searching for a particular node of the AST.

Particular embodiments will now be described with reference to the figures.

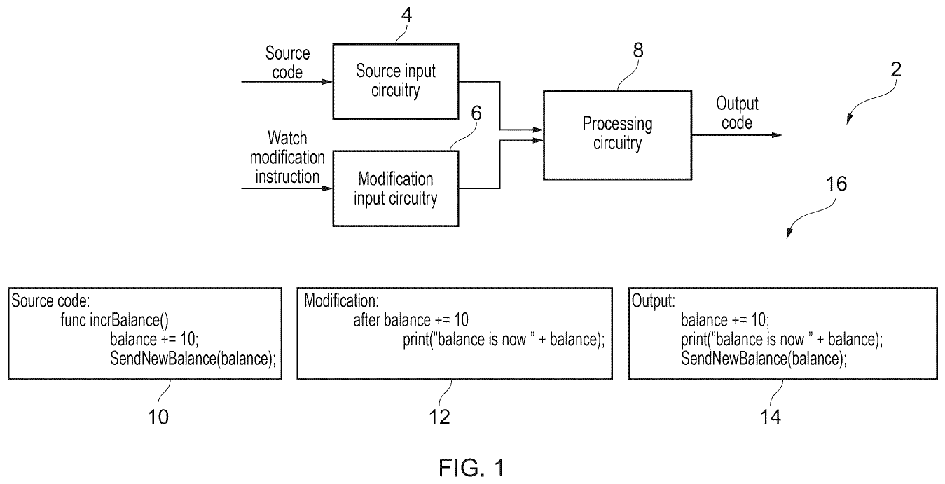

FIG. 1 shows an example system 2 that performs a source code transformation 16. The system 2 includes source input circuitry 4 that receives source code 10 and modification input circuitry 6 that receives modification instructions 12. The source code 10 and the modification instructions 12 are combined by processing circuitry 8 to produce output code 14.

By separating the source code from the modification circuitry it is possible to encapsulate different uses of the same source code. For instance, one set of modifications can be used to modify the source code for release candidacy while another set of modifications (e.g. removing temporary code) can be used to modify the source code for testing (e.g. adding additional debug information). Other modifications might allow the source code to be easily adapted for different platforms—thereby producing platform independent source code.

An example of one such use is given in FIG. 1. Here, the source code 10 contains a single function—incrBalance( ), which firstly causes a variable ‘balance’ to be incremented by 10 and secondly causes the new balance to be sent as part of a sendNewBalance function call each time the function is executed. During testing, it may be desirable to output the new version of the ‘balance’ variable each time it is incremented. However, it is not desirable for such information to be output in a release candidate. Consequently, a set of modification instructions 12 can be provided. Importantly, although an output is produced in which the source code has been modified, the originally provided source code is left untouched. The modification instructions refer to a location in the source code where the modification is to be provided. There are a number of ways of specifying such a location and these will be identified in the following description. Nevertheless, in these examples, the location can be specified at a level of granularity of a particular statement in the source code. By being able to specify the granularity so finely, it is possible to make more precise and varied modifications than might be possible if changes can only be made to, e.g. functions as a whole.

In the present techniques, the source code is interpreted and modified using one or more abstract syntax trees (ASTs). This avoids the need for text matching and makes it possible to identify sections of code quickly.

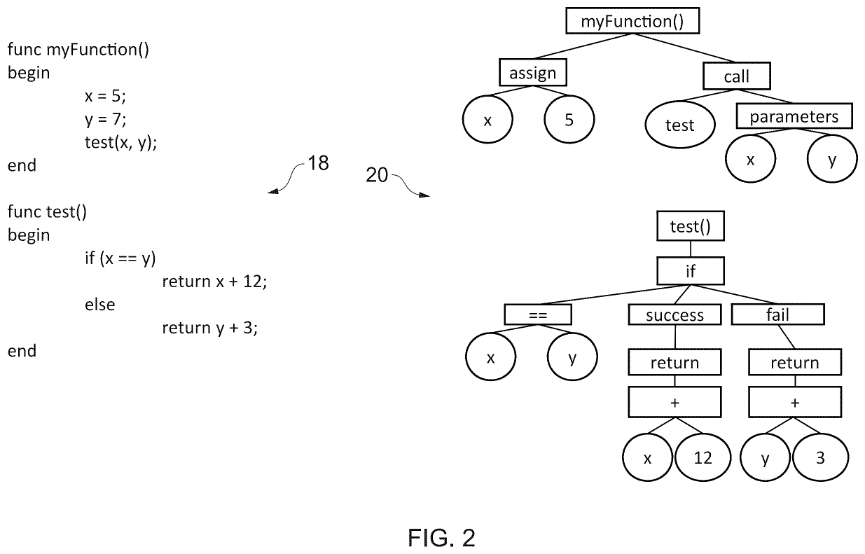

FIG. 2 illustrates the relationship between source code 18 and a set of ASTs 20. In particular, the source code 18 contains two functions—myFunction( ) and test( ) and these are illustrated as a pair of trees 20. In the ASTs, edges illustrate the relationships between nodes. For instance, an ‘if’ node is made of three sub-nodes. A first node indicates the comparison being performed. The second node indicates the action to be taken on success and the third node indicates the action to be taken on failure. Furthermore, an addition operator might have two sub-nodes—namely the two elements that are to be added together. If an addition is performed as a consequence of one branch of the ‘if’ statement (in the source code 18) then the addition node will be a child node of the success or failure branch of the ‘if’ statement node.

Note that in practice, all searching and replacement is carried out using ASTs with the present technique. For simplicity of reading, the description below may refer to matches or replacements that are made with respect to the source code. In practice, however, conversions are made from the source code to ASTs and the matching and replacements occur using the ASTs themselves rather than a textual matching/replacement taking place.

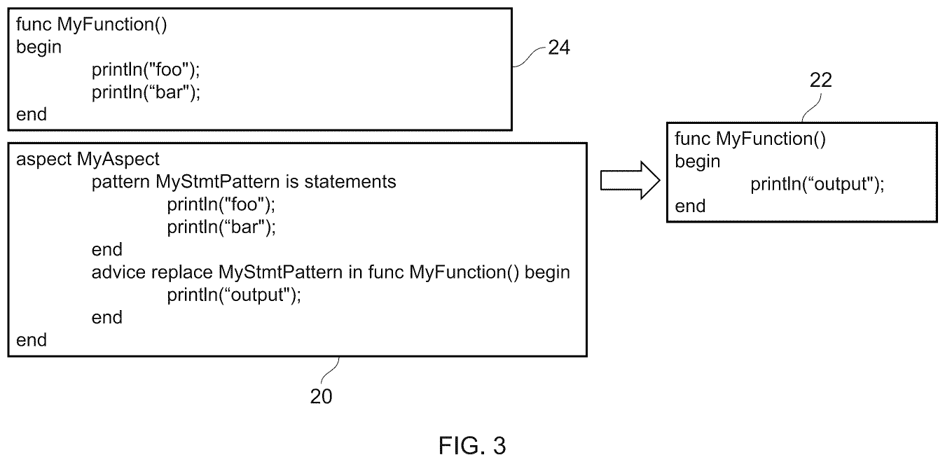

FIG. 3 shows an example in which the source code 24 causes two text strings—‘foo’ and ‘bar’ to be output. The modification instructions 21 define a pattern (MyStmtPattern) and advice. The pattern is used to perform a match against the source code (via ASTs). In this case, the source code is a sequence of two print statements (although a pattern can also specify one or more expressions). The advice dictates how the pattern is to be used to perform a replacement. In this case, it states that the pattern MyStmtPattern is to be replaced in the function MyFunction( ). Specifically with the code:
println(“output”);

The print lines within the pattern cause the words word ‘foo’ and ‘bar’ to each be output on their own line. These happen to match the two print statements in the source code and therefore the pattern (MyStmtPattern) is exactly found within the source code and replaced with the provided replacement code.

The resulting output 22 is therefore the MyFunction( ) function, with the old sequence of println statements replaced with a new sequence of println statements.

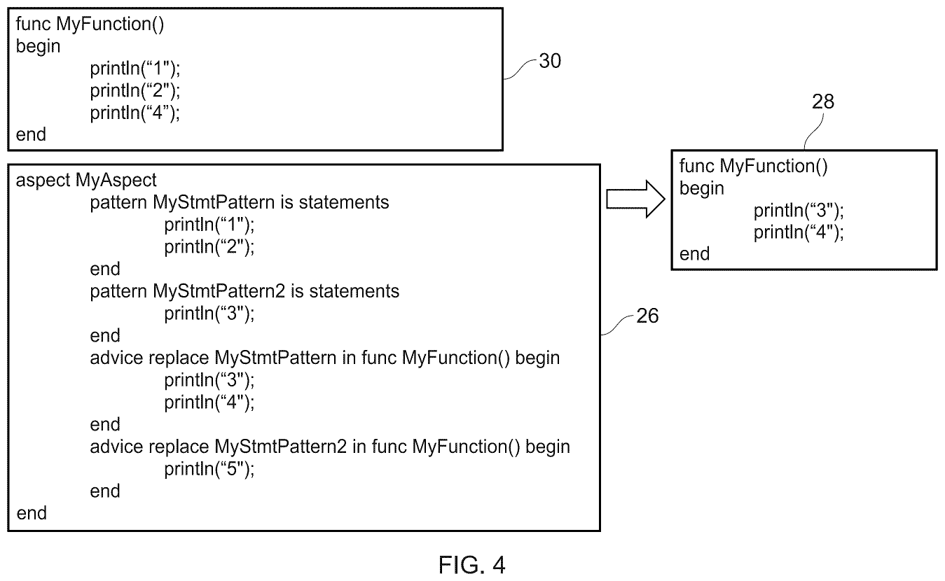

FIG. 4 shows an example in which the previous applied modification is treated as a compound statement when matching statements. That is to say that the modifications that are made are made within isolated ‘blocks’ and the matching that occurs does not cross those blocks. In particular, in FIG. 4, the source code 30 causes the numbers ‘1’, then ‘2’, then ‘4’ to be output. A first modification causes the statements:
println(“1”);
println(“2”);
in the function MyFunction( ) to be replaced with the code:
println(“3”);

The resulting modified source code would have the equivalent behaviour of:
println(“3”);
println(“4”);

Although there is a second modification that ostensibly matches on this text, it will not in fact match because in practice, the first line is actually isolated and thus is (in effect):
<begin Anonymous Compound Statement>
   println(“3”);
<end anonymous compound statement>
   println(“4”);

The resulting output code will cause the numbers ‘3’ and ‘4’ to be output in the function MyFunction( ).

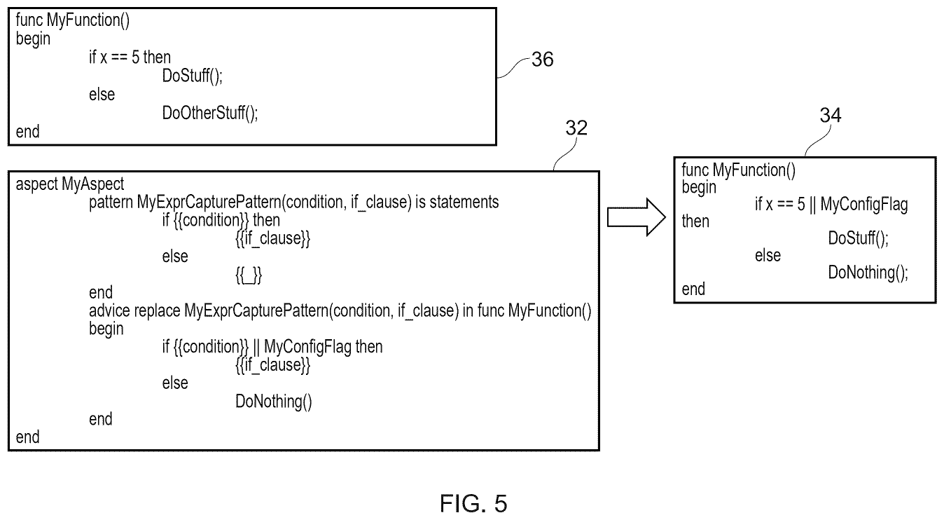

FIG. 5 shows an example that uses capture groups as part of the pattern. A capture group is used to match against a particular section of code. Often (but not always) a capture group can be referenced in the advice in order to reproduce the matched text. This allows for more complicated matches to be performed.

The source code 36 contains an ‘if’ statement. In particular, the source code 36 sets out that if x is five then the function DoStuff( ) is called. Otherwise the function DoOtherStuff( ) is called.

In this case the pattern identifies (in its definition) two capture groups named ‘condition’ and ‘if_clause’. The pattern is then defined as:
if {{condition}} then
   {{if_clause}}
else
{{_}}

Where the capture groups are to be used, the capture groups are named with surrounding curly braces, e.g. {{condition}} for the capture group ‘condition’ (which is an expression). In particular, the code (expression or statement) that fits into this space in the source code 36 is assigned the name ‘condition’. In the advice, this capture group can be referenced to insert the code that was matched against this group, as will be shown.

The matching for the capture group is greedy. That is to say that if there are several ways that the matching can be performed then the capture group will take as much as possible. For instance, consider the code:
x=1;
y=2;
z=3;

If the match being performed is:
pattern foo is statements
   x=1;
   {{rest}};
end
then the pattern ‘foo’ will match all three statements (as many as it can) rather than just the first two statements. Of course, in other embodiments, lazy matching may be used instead in which only the first two statements would match.

Greedy matching means that the capture group if_clause will match:
if r==2 then
   First( );
else
   Second( );

Rather than:
if r==2 then
   First( );

Within the pattern, a special type of capture group is provided—namely the anonymous capture group, which is simply given the identity ‘_’. An anonymous capture group means that the matched text, which is captured, is not available for use in the advice. Thus, one cannot use {{_}} in the advice to insert the text against which the matching was made.

So in the example of FIG. 5, the pattern covers an if-else statement. The condition of the if statement and the if-clause (e.g. the action to be performed if the statement's condition is true) are both captured and are available in the advice for reuse. The else-clause (e.g. the action to be performed if the statement's condition is false) is captured anonymously.

The advice sets out that the entire matched pattern (e.g. the if statement in its entirety) is to be replaced within the function MyFunction by:
if {{condition}}∥MyConfigFlag Then
   {{if_clause}}
else
   DoNothing( );

As explained above, the capture group identifiers are replaced by the captured text. Thus, in effect, the condition line becomes:
if {{condition}}∥MyConfigFlag Then

The ‘if’ condition therefore remains, but is expanded to also trigger if MyConfigFlag is true. The advice continues by indicating that this is then followed by the keyword ‘else’ (as is in the pattern) followed by DoNothing( ). Thus, whatever was matched as the else clause is replaced by DoNothing( ). The previous text DoOtherStuff is captured in the anonymous capture group and so is not available in the advice.

The original source code 36 is therefore modified so that if x is five then DoStuff( ) is still called. But this function is also called if MyConfigFlag is set. However, whereas the original source code caused DoOtherStuff( ) to be called if the conditions were not met, the modification causes DoNothing( ) to be called instead.

Although the above explanation implies that the matching is performed using text for simplicity, it will be appreciated that the matching is actually performed using ASTs as described earlier. Consequently, the expression a+b*c+d matches a+(b*c)+d and a+b*c+d. That is, regardless of which of these is actually written in the source code, a match will occur..

Since it is not known what code in the source code 36 the pattern will be matched against, type checking is generally not performed on the modification instructions 32. To the extent that type checking is performed, this may be performed on the final output code 34 (e.g. at a time of compilation).

So far, the previous examples have referred to applying advice using patterns. However, there are other ways in which statements can be identified for modifications to be applied.

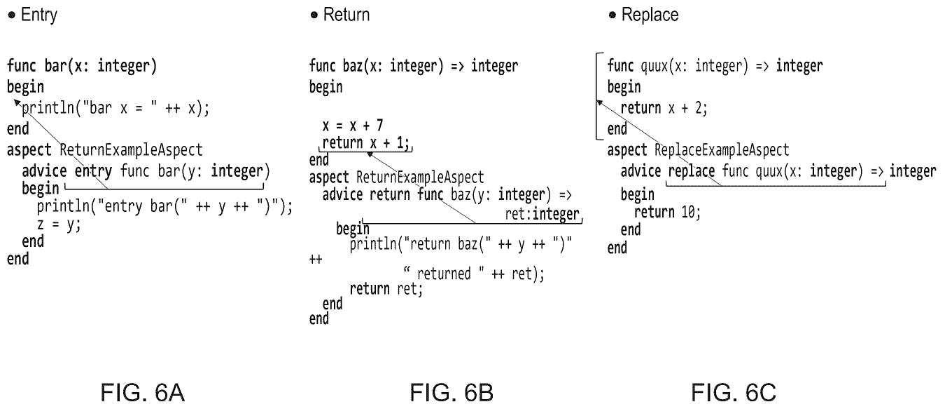

FIG. 6A illustrates a modification in which the given location is at the entry into a function. In this case, the advice line:
advice entry func bar(y: integer)

Means that within the function bar(y) (with y as an integer), new code should be inserted at the start of the function. The new code is specified as:
println(“entry Bar(“++ y ++”)”);
z=y;

This code will therefore be inserted at the beginning of the function, so that the content of the bar(y) function reads:
println(“entry bar(“++ y ++ ”)”);
z=y;
println(“bar x=” ++ x);

FIG. 6B illustrates a modification in which the given location is the return or exit from a function. In this case, the advice line:
advice return func baz(y: integer)=>ret: integer

Means that within the function baz(y) (with y as an integer), with the function also returning an integer, new code should replace the return statement. The new code is specified as:
println(“return baz(“++ y ++”)” ++ “returned” ++ ret);
   return ret;

This code will therefore replace the return statement in baz(y). In this case, therefore, the content of baz(y) will be:
x=x+7
println(“return baz(“++ y ++”)” ++ “returned” ++ret);
   return ret;

FIG. 6C illustrates a modification in which the given location is the function itself and thus the entirety of the body of the function itself is replaced. In this case, the advice line:
Advice Replace Func Quux(x: Integer)=>Integer

Means that within the function quux(x) (with x as an integer), with the function also returning an integer, new code should replace the body of the function.

Originally, the body of the code is specified as:
return x+2;

Therefore, this code is replaced by the code:
return 10;

It is not necessary that code modifications can be made to locations that are more functionally defined. That is to say that the location can be specified based on the action performed by the code rather than its particular signature or declaration.

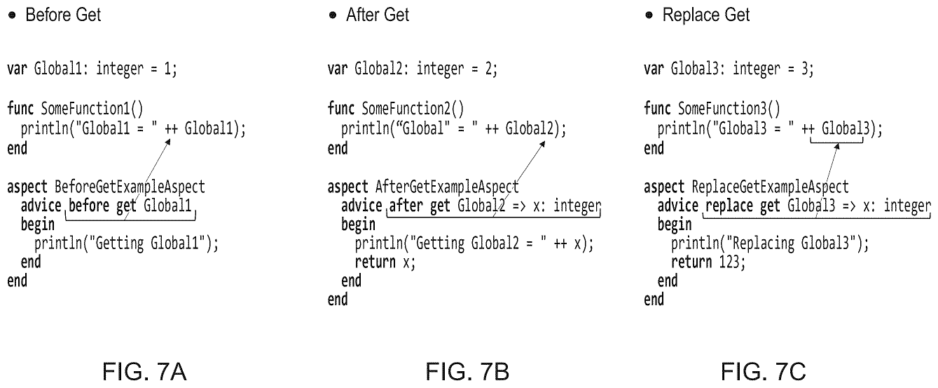

FIGS. 7A, 7B, and 7C show examples where the location is specified based on the function that a (global) variable is read. It will be appreciated that such modifications can be used to add (for instance) debug statements into a program without the underlying source code being modified. Consequently, it is possible to have confidence that the underlying code is not be improperly modified before debugging or after debugging occurs.

FIG. 7A shows an example in which the location is specified as one or more places in the code before a global variable is obtained. The advice line specifies:
advice before get Global1

Which means that the modification is to be made prior to the variable Global1 being read. Note that in many cases, a write to this variable will incorporate a read. For instance, if Global1 is incremented then this involves reading Global1 in order to increment the value. Nevertheless, if the original source code was:
println(“Global1=” ++ Global1);

As is the case in FIG. 7A, and if the body of the advice line indicated that the new code to be added was:
println(“getting Global1”);
then the resulting output would effectively read:
println(“Global1=” ++ (println(“Getting Global1”), Global1));
using the syntax of C's comma operator where (a, b) evaluates a then actually uses the value of b.

in FIG. 7B, the modification is made in locations after the variable Global1 is read. As in the case with FIG. 7A note that a write to a variable may also involve a read to that variable. Here, the advice line takes the format:
advice after get Global2=>x: Integer

So that after the variable Global2 is read (thereby producing an integer named x), the body of the advice line will be inserted. Here the body is:
println(“Getting Global2=” ++ x);
   return x;

Thus, for the source code:
println(“Global”=“++ Global2);

The following output would be produced:
println(“Global=” ++{let x=Global2; println(“Getting Global2=” ++ x); return x});

FIG. 7C illustrates an example in which the location is the location itself where a global variable is obtained, such that the obtaining itself is replaced. Once more, note that a read or get of a variable may be incorporated within a write to that variable. In this case, the advice line states:
advice replace get Global3=>x: Integer

And so any get of the variable Global3 is replaced by code. Here, we again assign the variable x to the retrieved variable so that it can be referenced in the replacement code. The replacement code is:
println(“replacing Global3”);
   return 123;

Thus, the source code:
println(“Global3=” ++Global3);

Would result in the output:
println(“Global3=” ++ {println(“Replacing Global3”); return 123;});

Note that, as previously explained, the reference to the location is described functionally (by whether the code gets or sets a given variable). The modification can therefore take place in several locations regardless of the function they are found in, for instance.

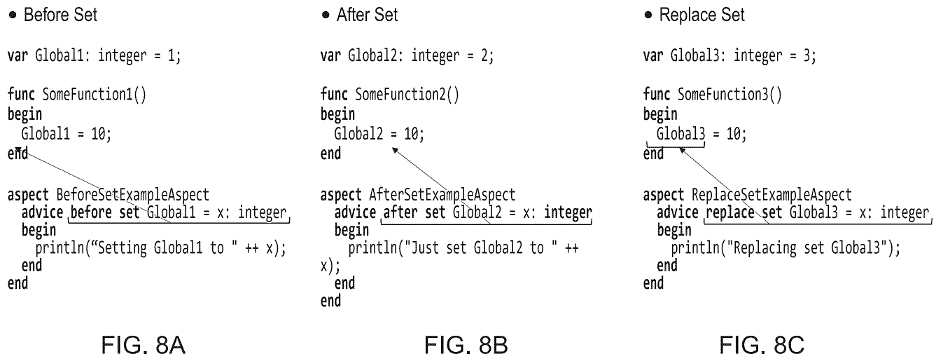

FIGS. 8A, 8B, and 8C describe comparable examples in which a (global) variable is set. Note that in these examples, for simplicity, the variable is only set - it is not updated and therefore not read at any point. In each of FIGS. 8A-8C, the originating source code is simply an assignment to the global variable (either Global1,Global2, or Global3) of the value 10, e. g (in FIG. 8A):
Global1=10

In the case of FIG. 8A, the advice line is:
advice before set Global1=x: Integer

Meaning that the modification is to be made (immediately) before any setting of Global1. The value x: integer means that within the setting, the value x will be used, which is the value to which Global1 is being set and that value is an integer. The body of the advice line is:
println(“setting Global1 to” ++ x);

The source code is therefore modified to become:
Global1=10
println(“Setting Global1 to” ++ x);

In FIG. 8B, the advice line is:
advice after set Global2=x: integer

This indicates that the modification is to be made (immediately) after any setting of Global2. Again, the value x: integer is bound to the replacement value (e.g. so that it can be referenced inside the body of the advice line). The body of the advice line is:
println(“Setting Global2 to” ++ x);

The source code is therefore modified to become:
println(“Setting Global2 to” ++ x);
Global2=20

Finally, FIG. 8C has an advice line:
advice replace set Global3=x: integer

This indicates that the modification is to be made directly to the setting of Global3 (thereby replacing it). Once more, the value of x can be referenced in the body. The body of the advice line is:
println(“Replacing set Global3”);

The source code is therefore modified to become:
println(“Replacing set Global3”);

A number of different techniques have been presented here, which can be used to perform modifications at a fine level of granularity to source code—e.g. at the level of individual statements/expressions. In practice a number of different modification instructions may be provided (e.g. as illustrated in FIG. 4) and source code may be modified according to a number of these modifications.

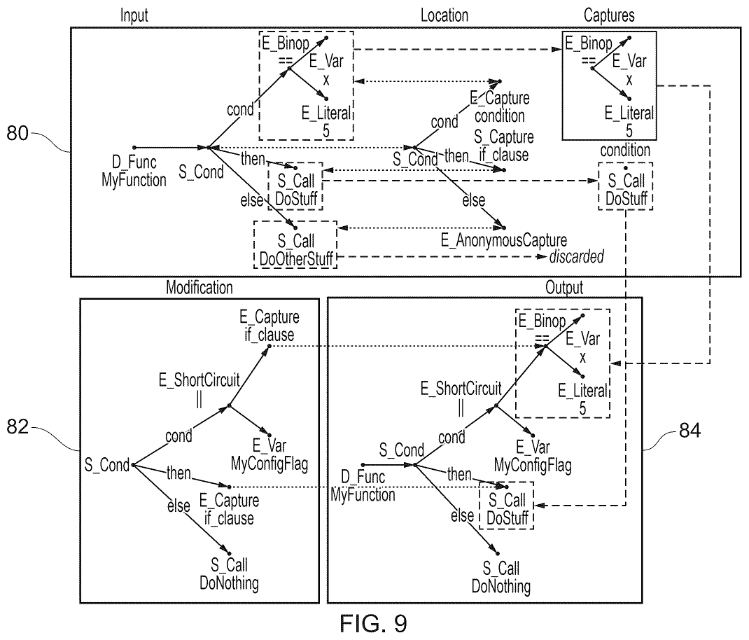

FIG. 9 shows the example from FIG. 5 as a set of ASTs of an input 80, location and modification 82 and the corresponding output 84. In the example, statement captures at the location use the S_Capture node and expression captures at the location use the E_Capture node. The S_Capture node greedily matches one or more contiguous statements in the statement list, including any nested statements. The E_Capture node matches a (sub-)expression subtree. The input 80 is searched for subtree instances matching the location. The dotted lines show how the nodes in the location are matched against the nodes in the input 80. In the example the location matches the subtree rooted at the S_Cond node. The relevant capture identifier is associated with the matched statement sublist or (sub-)expression subtree. In the example the condition capture identifier is associated with the expression subtree rooted at the E_Binop node and the if_clause capture identifier is associated with the statement sublist comprising a single S_Call statement. The sub-tree in the input 80 rooted at the S_Cond node that was matched by the location is replaced by the modification. The E_Capture and S_Capture nodes in the modification represent references to captures and are substituted for the relevant subtree associated with the capture identifier above.

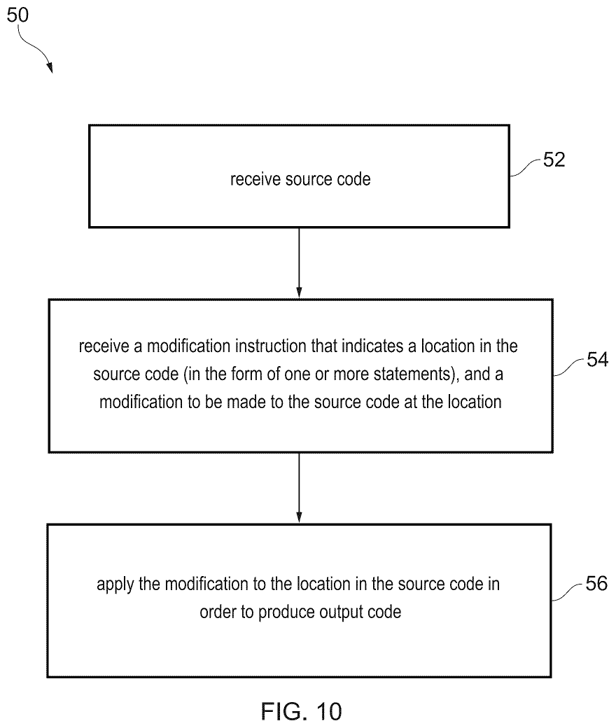

FIG. 10 illustrates a method of data processing in accordance with some embodiments. The method is provided in the form of a flowchart 50. At a step 52, source code 10 is received by source input circuitry 4. This may take the form, for instance, of a compiler or pre-processor running on a CPU. At a step 54, a modification instruction (or instructions) 12 are received by modification input circuitry 6. This indicates one or more locations in the source code. Each location may take the form of one or more statements or expressions and may be defined functionally (based on what the statements do) or directly (based on what the statements are). For instance, the location may be defined based on a signature. The modification instructions 12 also include a modification to be made at each location. The modification may be an addition, deletion, replacement, etc. Then at step 56, the modifications 12 are applied to the one or more locations in the source code in order to produce output code 14. In practice, this is achieved through the generation of ASTs (e.g. from the source code and any code for which a match is to be performed). The output code is then generated using those ASTs. The output code may be subject to further compilation and/or assembly.

In some examples, the modification instructions can indicate one or more changes to be made to source code at a time that a given expression or variable may change.

By separating the source code from the watch modification instructions it is possible to encapsulate different uses of the same source code. For instance, one set of watch modifications can be used to modify the source code for release candidacy while another set of watch modifications (e.g. removing temporary code) can be used to modify the source code for testing (e.g. adding additional debug information). Other watch modifications might allow the source code to be easily adapted for different platforms—thereby producing platform independent source code. In addition to this, it is possible to ‘emulate’ the use of watchpoints (e.g. as provided for in a debugger) in a more efficient manner. For instance, by modifying the source code 10 to produce output code 14, which is then compiled, the resulting ‘watched’ variables or expressions run at approximately the same speed as the unmodified source code.

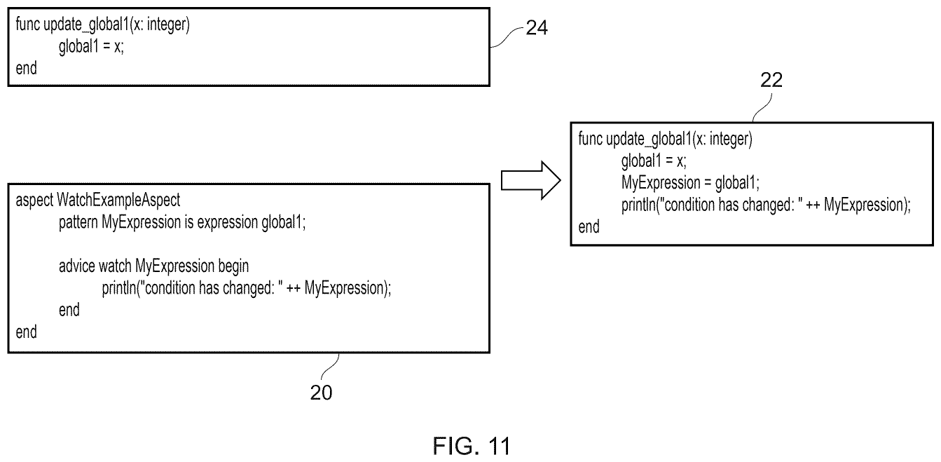

FIG. 11 shows an example of the application of watch modification instructions 21 to source code 24 to produce an output 22. In this example, the source code 24 merely contains a function update_global1, which takes an integer x and sets the global variable global1 to the value of x.

The watch modification instructions 21 set out a pattern. The pattern is used to help define one more locations against which a watch modification (or set of watch modifications) is/are to be made. The pattern is defined as follows:
pattern MyExpression is expression global1;

In other words, the pattern is given the name ‘MyExpression’ and is defined as the expression ‘global1’. That is to say that the pattern covers any change of the expression global1.

The watch modification instructions also contain an advice section, which dictates how matches against a pattern are to be made. Here, the first line of the advice section sets out:
advice watch MyExpression

The keyword ‘watch’ here means that the locations to be modified indicate portions of the source code where a particular expression may change. The advice line also sets out that what is being watched is defined by the pattern ‘MyExpression’, which is explained above to be the expression global1. In other words, this line sets out that a modification should be made to any location in the source code where a change to the expression global1 may take place.

The modification to be made is defined by the remainder of the advice section, which is set out as:
println(“expression has changed:” ++ MyExpression);

This simply prints the text ‘expression has changed:’ followed by the expression. Absent any further qualification, the specified modification is an insertion that is inserted after the change has been made. Therefore at any location in the source code 24 where global1 will change.

As can be seen in FIG. 11, the output code 22 therefore includes a function update_global1 that updates the global1 variable and then prints the specified text, which causes the updated version of the expression to be output (here, global1).

In practice, the expression may be more complicated that an individual variable.

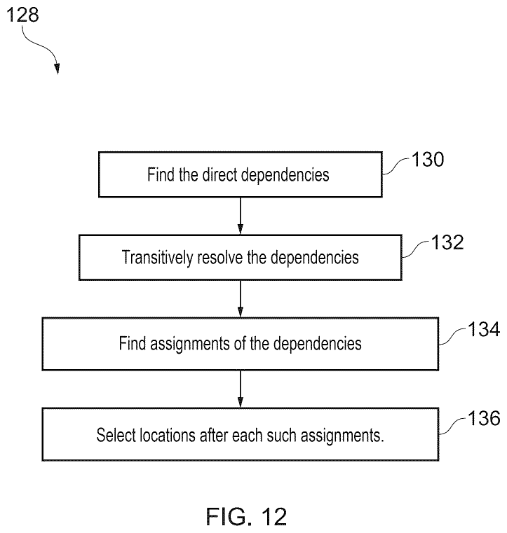

FIG. 12 illustrates a process, in the form of a flowchart 128, which can be used to handle the determination of locations in the source code 24 that are to be modified in accordance with a watch modification. The process starts at a step 130 where direct dependencies are located. For example, if the expression being watched was global1+global2 then the direct dependencies of this would be global1 and global2. At step 132, the dependencies are transitively resolved. This process is recursive or iterative. For instance, if in part of the source code it transpires that global2 is dependent on global3 (e.g. global2=global3+5) then global3 is added to the dependencies list. As another example, the expression might refer to a function call. For instance, the code might specify that global2=calculateGlobal3( ). In that case, the function calculateGlobal3( ) must be examined in order to determine any dependencies on the return result of calculateGlobal3. For instance, if the code is simply ‘return global4’ then global4 is also a dependency of global2. At step 134, the assignments of the dependencies are located. That is, if the direct/indirect dependencies are identified as global1, global2, and global3 then any location in the source code where an assignment to one of those dependencies is made is a point where the watched expression can change. Consequently the locations are set, in step 136, as being after any of the assignments are made that are identified in step 134.

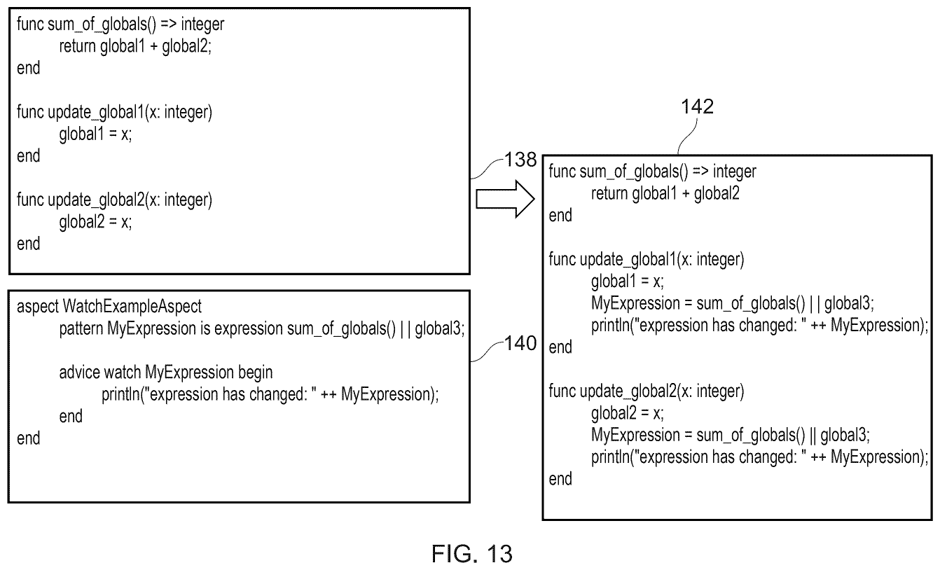

FIG. 13 illustrates a more complicated example of source code 138 and a watch modification instruction 140 to illustrate the process with respect to FIG. 12. Here, the source code contains a first function sum_of_globals( ) that returns an integer in the form of the sum of global1 and global2. A second function update_global1( ) takes an integer as a parameter and sets global1 to that integer. A third function update_global2( ) takes an integer as a parameter and sets global2 to that integer.

The watch modification instruction 140 is similar to the instruction 26 in FIG. 2 but in this example, the pattern is set as:
pattern MyExpression is expression sum_of_globals( )∥global3;

In other words, the expression sum_of_globals( )∥global3 is watched for changes. Applying the flow of FIG. 12. Firstly, we consider the direct dependencies. In this case, the direct dependencies are sum_of_globals( ) and global3. Secondly, we transitively resolve the dependencies. Global3 does not depend on anything, so this has nothing further to examine. The function sum_of_globals( ) depends on global1 and global2. Therefore these variables become dependencies. We then check those dependencies but neither global1 nor global2 depend on any other variable or function. Therefore, we identify our direct and indirect dependencies as global1, global2, and global3. Thirdly, we look for assignments of the dependencies. Assignments take place within the functions update_global1(x) and update_global2(x). Those locations are therefore set to have the modification added.

Thus, in the output code 142, the update_global1(x) and update_global2(x) functions are updated to produce:
println(“expression has changed:” ++ MyExpression);

Prior to the assignments being made to global1 and global2 respectively.

Note that the determination of locations where assignments are made could be made using text matching—for instance by searching for the text “global1=”. Although this process can be fast, it can lead to inaccuracies. For example, if global1 and the=symbol are of different lines, or if there is a comment between them or if global1 is actually a macro that evaluates to a different symbol then traditional text matching may not work. Consequently, assignments (and indeed, other searches) are achieved by using an abstract syntax tree (AST) as previously described. That is, the tree or trees that are formed from parsing the source code are searched for assignment nodes (in this case).

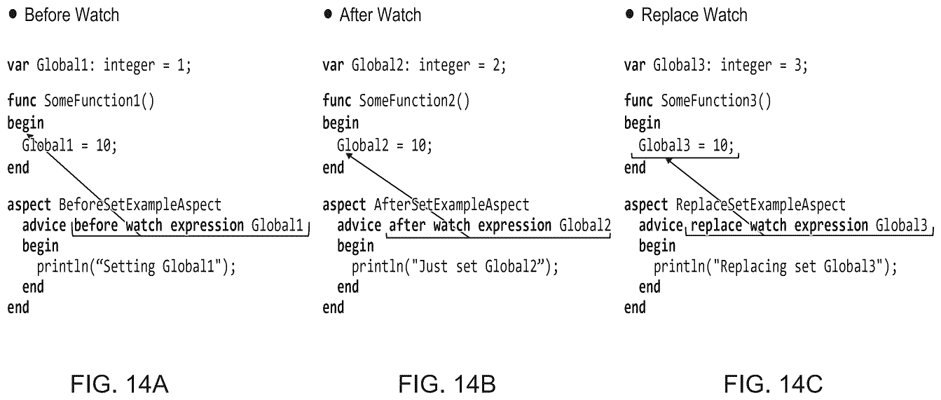

FIGS. 14A, 14B, and 14C describe comparable examples in which an expression is watched. In each of FIGS. 14A-14C, a modifications are made in different ways relative to the point at which changes could be made to the expression or variable. In each case, for simplicity, the expression being watched is simply a global variable (either Global1, Global2, or Global3). Meanwhile, the source code contains a simple function that sets the global variable to ‘10’. That is, for instance:
Global1=10

In the case of FIG. 14A, the advice line is:
advice before watch expression Global1

Meaning that the modification is to be made (immediately) before any point at which Global1 will change. The body of the advice line is:
println(“setting Global1”);

The content of SomeFunction1( ) would therefore be modified to:
println(“Setting Global1”);
Global1=10

In FIG. 14B, the advice line is:
advice after watch expression Global2

This is simply an explicit way of describing the default behaviour shown in respect of FIGS. 11 and 13. That is, the modified code is inserted after code that causes a change to Global2. This syntax may be relevant to an implementation that, for instance, defaults to what is illustrated in FIG. 14A where the modified code is inserted before the assignment.

Finally, FIG. 14C has an advice line:
advice replace watch expression Global3

This indicates that the modification is to be made directly to the setting of any variable that would cause Global3 to be affected (thereby replacing it). The body of the advice line is:
println(“Replacing set Global3”);

The function SomeFunction3( ) is therefore modified to become:
println(“Replacing set Global3”);

A number of different techniques have been presented here, which can be used to perform modifications at particular points in the code where an expression or variable might be modified. This code is inserted at, for instance, compile time, and thus does not necessitate dynamic checks of variables and expressions at runtime (e.g. one instruction at a time), which can be time consuming and resource intensive. Several techniques have been illustrated in isolation. In practice, the processing circuitry 8 may react to multiple such watch modification instructions that are provided.

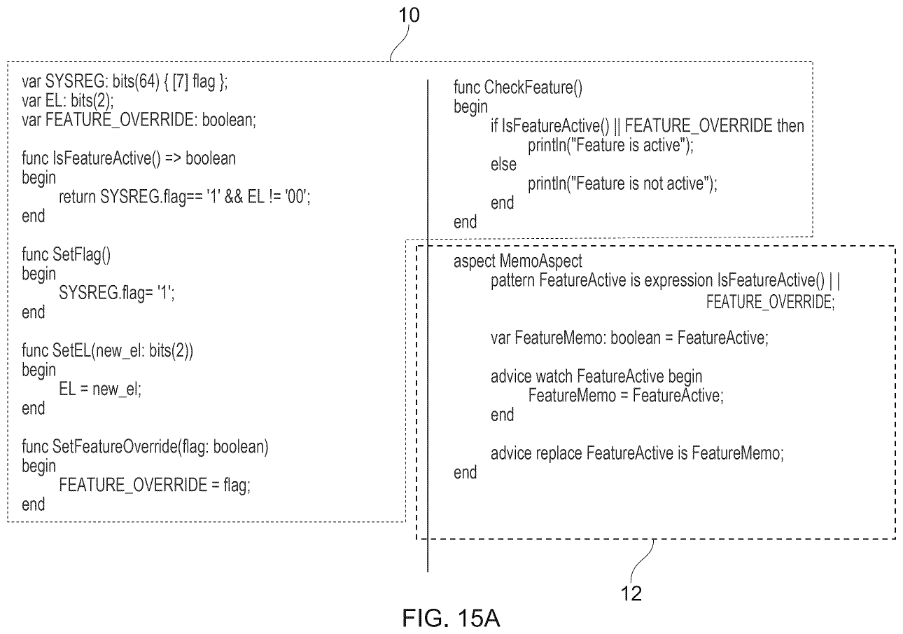

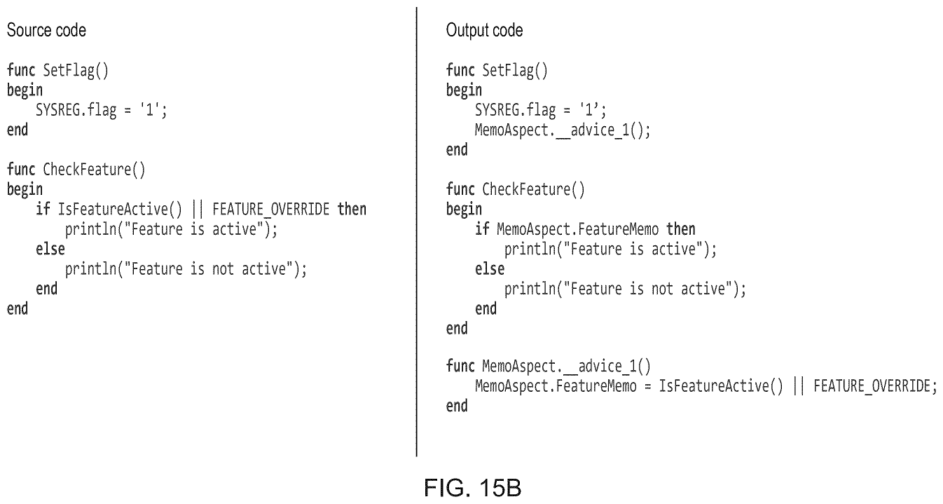

FIG. 15A illustrates an example of memoisation. In particular, an expression may be used in source code, which changes rarely but is expensive to calculate. The memoisation means that the value is essentially ‘cached’ or stored in a variable that is kept updated so that it can be reused without being calculated each time the variable is needed.

Source code 10 is provided in which a function—CheckFeature( ) provides output to indicate whether a feature is active or not. The feature is said to be active either if the flag FEATURE_OVERRIDE is set or if the function IsFeatureActive( ) is set. Modification instructions 12 define a pattern that refers to the expression used in the CheckFeature( ) function—namely IsFeatureActive( )∥FEATURE_OVERRIDE. The modification instructions then define a new variable FeatureMemo, which is a Boolean. Its initial value is set to IsFeatureActive( )∥FEATURE_OVERRIDE. A watch is then set on the FeatureActive expression. Consequently, each time the expression IsFeatureActive( )∥FEATURE_OVERRIDE may change, code is executed. The code to be executed is FeatureMemo=FeatureActive. In other words, the variable FeatureMemo is set to being the expression FeatureActive.

The consequence of these instructions is that each time either IsFeatureActive( ) or FEATURE_OVERRIDE might change, the variable FeatureMemo is updated to being the new value.

Then, a final replacement is made. This replaces instances of the expression FeatureActive with the expression (variable) FeatureMemo. In other words, each time IsFeatureActive( ) or FEATURE_OVERRIDE are read, the code will be changed to instead read the variable FeatureMemo.

Thus, FeatureMemo is updated each time IsFeatureActive( ) or FEATURE_OVERRIDE are changed and reads to IsFeatureActive( ) or FEATURE_OVERRIDE are replaced by reads to FeatureMemo.

FIG. 15B illustrates the relevant initial source code and the output code that results. As can be seen, the modification process has encapsulated the updating of the FeatureMemo variable within a function—MemoAspect.__advice_1( ). From FIG. 15A, it can be seen that this will occur if SYSREG.flag changes—which occurs in the SetFlag( ) function. Hence, the revised SetFlag( ) function has been updated to call MemoAspect.__advice_1( ).

Meanwhile, the CheckFeature( ) function checks MemoAspect. FeatureMemo rather than performing IsFeatureActive( )∥FEATURE_OVERRIDE.

Note that in this example, as explained, some of the replacement code has been inserted into its own function. This is an optional step and can be carried out if the code will be frequently reused. The replacement code could have instead been inserted inline according to the usual steps for inline expansion.

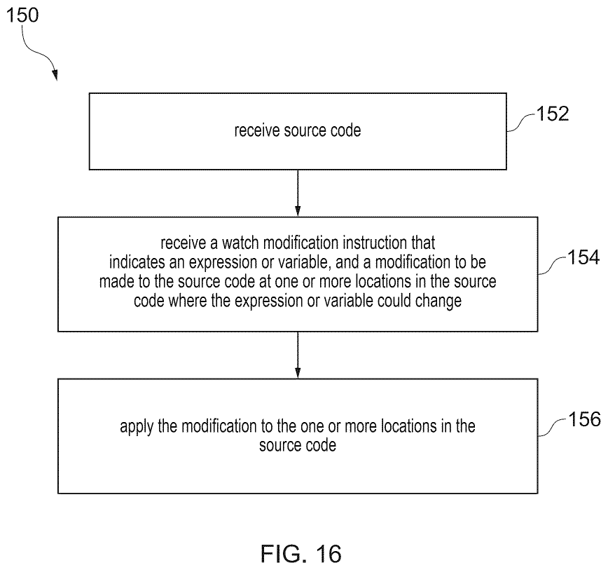

FIG. 16 illustrates a method of data processing in accordance with some embodiments. The method is provided in the form of a flowchart 150. At a step 152, source code 10 is received by source input circuitry 4. This may take the form, for instance, of a compiler or pre-processor running on a CPU. At a step 154, a watch modification instruction (or instructions) 12 are received by modification input circuitry 6. The watch modification instruction indicates an expression (e.g. a variable) and a modification to be made to the source code at one or more points where that expression or variable has the potential to change. As previously discussed with respect to FIG. 12, this may be determined iteratively by looking for indirect dependencies. Then at step 156, those modifications are made in the source code.

The present technique does not involve the execution or emulation of the source code, instead relying on assessing (through the use of ASTs) locations where the source code instructs an assignment to be made to a variable that would affect the outcome of the specified (watched) variable or expression if executed. Modifications are made at these points in the source. As a consequence of this, there is no need to dynamically test the value of the variable after execution of each instruction to see whether the variable has changed.

Note that this still does not necessitate that the watched variable or expression has changed—merely that an assignment has been made that could have changed it. For instance if the variable x is five and if an assignment of the value five is made to x, then an assignment has happened (and the watch modification would occur) but the value has not actually changed.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

The present technique could be configured as follows:
(1) A data processing apparatus comprising:
   source input circuitry configured to receive source code;
   modification input circuitry configured to receive a watch modification instruction that indicates an expression or variable, and a modification to be made to the source code at one or more locations in the source code where the expression or variable could change; and
   processing circuitry configured to apply the modification to the one or more locations in the source code.
(2) The data processing apparatus according to (1), wherein
   the processing circuitry is configured to generate an abstract syntax tree from the source code, and to identify the one or more locations using the abstract syntax tree.
(3) The data processing apparatus according to any one of (1)-(2), wherein
   when the modification instruction comprises a before keyword, the processing circuitry is configured to determine the one or more locations as points immediately before where the expression or variable could change.
(4) The data processing apparatus according to any one of (1)-(3), wherein
   when the modification instruction comprises an after keyword, the processing circuitry is configured to determine the one or more locations as points immediately after where the expression or variable could change.
(5) The data processing apparatus according to any one of (1)-(4), wherein
   when the modification instruction comprises a replaces keyword, the processing circuitry is configured to determine the one or more locations as points where the expression or variable could change.
(6) The data processing apparatus according to any one of (1)-(5), wherein
   the processing circuitry is configured to determine the one or more locations by including assignments made to the variable.
(7) The data processing apparatus according to any one of (1)-(6), wherein
   the processing circuitry is configured to determine the one or more locations by determining dependencies of the expression.
(8) The data processing apparatus according to any one of (6)-(7), wherein
   the processing circuitry is configured to determine the one or more locations by including assignments made to the dependencies.
(9) The data processing apparatus according to any one of (6)-(8), wherein
   the dependencies of the expression include one or more indirect dependencies of the expression.
(10) The data processing apparatus according to any one of (1)-(9), wherein
   the one or more locations in the source code are determined without executing the source code.
(11) The data processing apparatus according to any one of (1)-(10), wherein
   an identifier may be used in the modification to reference the expression or variable.
(12) a Data Processing Method Comprising:
   receiving source code;
   receiving a watch modification instruction that indicates an expression or variable, and a modification to be made to the source code at one or more locations in the source code where the expression or variable could change; and
   applying the modification to the one or more locations in the source code.
(13) A non-transitory storage medium configured to store a computer program that, when executed on a computer causes the computer to:
   receive source code;
   receive a watch modification instruction that indicates an expression or variable, and a modification to be made to the source code at one or more locations in the source code where the expression or variable could change; and
   apply the modification to the one or more locations in the source code.

We claim:

1. A data processing apparatus comprising:
source input circuitry configured to receive source code;
modification input circuitry configured to receive a watch modification instruction that indicates an expression or variable, and a modification to be made to the source code at one or more locations in the source code where the expression or variable could change; and
processing circuitry configured to apply the modification to the one or more locations in the source code.

2. The data processing apparatus according to claim 1, wherein
the processing circuitry is configured to generate an abstract syntax tree from the source code, and to identify the one or more locations using the abstract syntax tree.

3. The data processing apparatus according to claim 1, wherein
when the modification instruction comprises a before keyword, the processing circuitry is configured to determine the one or more locations as points immediately before where the expression or variable could change.

4. The data processing apparatus according to claim 1, wherein
when the modification instruction comprises an after keyword, the processing circuitry is configured to determine the one or more locations as points immediately after where the expression or variable could change.

5. The data processing apparatus according to claim 1, wherein
when the modification instruction comprises a replaces keyword, the processing circuitry is configured to determine the one or more locations as points where the expression or variable could change.

6. The data processing apparatus according to claim 1, wherein
the processing circuitry is configured to determine the one or more locations by including assignments made to the variable.

7. The data processing apparatus according to claim 1, wherein
the processing circuitry is configured to determine the one or more locations by determining dependencies of the expression.

8. The data processing apparatus according to claim 6, wherein
the processing circuitry is configured to determine the one or more locations by including assignments made to the dependencies.

9. The data processing apparatus according to claim 6, wherein
the dependencies of the expression include one or more indirect dependencies of the expression.

10. The data processing apparatus according to claim 1, wherein
the one or more locations in the source code are determined without executing the source code.

11. The data processing apparatus according to claim 1, wherein
an identifier may be used in the modification to reference the expression or variable.

12. A data processing method comprising:
receiving source code;
receiving a watch modification instruction that indicates an expression or variable, and a modification to be made to the source code at one or more locations in the source code where the expression or variable could change; and
applying the modification to the one or more locations in the source code.

13. A non-transitory storage medium configured to store a computer program that, when executed on a computer causes the computer to:
receive source code;
receive a watch modification instruction that indicates an expression or variable, and a modification to be made to the source code at one or more locations in the source code where the expression or variable could change; and
apply the modification to the one or more locations in the source code.
